(19) United States
(12) Patent Application Publication
(10) Pub. No.: US 2008/0143890 A1
(43) Pub. Date: Jun. 19, 2008

(54) DIGITAL PICTURE FRAME DEVICE AND SYSTEM

(75) Inventors: Allan Rosencwaig, Danville, CA (US); Li Chen, Fremont, CA (US)

Correspondence Address: DLA PIPER US LLP, 2000 UNIVERSITY AVENUE, E. PALO ALTO, CA, 94303-2248, US

(73) Assignee: ARIS DISPLAYS, INC.

(21) Appl. No.: 11/838,191

(22) Filed: Aug. 13, 2007

Related U.S. Application Data
(60) Provisional application No. 60/872,231, filed on Nov. 30, 2006.
(60) Provisional application No. 60/880,863, filed on Jan. 16, 2007.

(51) Int. Cl. H04N 5/64

(52) U.S. Cl. 348/836; 348/E05.128

(57) ABSTRACT

A digital picture frame device and system are described. The system includes a server, a computer, and a digital picture frame device. The system also includes a first communications link for transmitting digital content from the server to the computer and a second communications link for transmitting digital content from the computer to the digital picture frame. The digital picture frame device includes a display screen, a frame, an input, memory and control circuitry. The system includes encrypted digital content on the server, decryption circuitry on the computer for decrypting the content from the server, and circuitry in the digital picture frame for displaying the decrypted digital content on the frame.

This application claims the benefit of U.S. Provisional Application No. 60/872,231, filed Nov. 30, 2006, and U.S. Provisional Application No. 60/880,863, filed Jan. 16, 2007, both of which are incorporated herein by reference.

### FIELD OF THE INVENTION

The present invention relates to consumer electronic devices commonly referred to as digital picture frames.

### BACKGROUND OF THE INVENTION

Currently, several manufacturers offer a consumer electronic device commonly described as a digital photo or picture frame. This device usually consists of a relatively small LCD screen, typically 5.6″ to 10.4″ diagonal, set into a frame suitable for a photo or picture. Digital picture frame devices are not mobile devices, but rather are desktop or wall-mounted devices. Furthermore, digital picture frame devices are not television devices. The user loads his photos into the digital picture frame from the memory of a digital camera or from a memory card. The digital picture frame can then display a single photo or perform a slide show of the photos then stored in its internal memory. Some digital picture frames can also display video. A digital picture frame thus provides greater flexibility and use than the traditional desk or wall mounted picture frame.

Current digital picture frames suffer from several serious drawbacks. These devices generally have low resolution and poor image quality. These drawbacks are usually the result of using display screens with inadequate pixel count and from the use of lower-quality analog video drivers. In addition, the methods of providing pictures to the frames are typically limited, and the frames must accept many different types of image memory inputs. This requires users to properly format and size their images before downloading them into the digital picture frame. This can be a difficult task for the average user of this device, and at the very least substantially adds to the number of steps required by a user to create an image that is effectively optimized for the specific digital picture frame. Another major drawback is the lack of high-quality image and video content beyond those that have been supplied by the user himself. This seriously limits the applications and general utility for such devices. Thus, there is a need for digital picture frame devices that can display high-resolution images with good quality and little distortion. In addition there is a need for a system that can provide a more convenient and automated mechanism to download both user-generated and third-party images and videos, into the digital picture frame. Finally there is a need to provide third-party digital content that includes high-quality images and video at low cost to the user.

### SUMMARY OF THE INVENTION

The aforementioned problems are solved by a digital picture frame device for displaying digital content, which includes a display screen, a frame surrounding a periphery of the display screen, wherein the frame provides a visual border around the periphery of the display screen, an input for receiving digital content, wherein at least some of the digital content is encrypted, decryption circuitry for decrypting the encrypted digital content, and control circuitry for controlling a display of the decrypted digital content on the display screen.

In another aspect, a digital picture frame system for displaying digital content includes a server for storing digital content, wherein at least some of the digital content is encrypted, a first communication link for transmitting the digital content from the server, a computer for receiving the digital content from the server, and for decrypting the encrypted digital content and displaying the digital content, a second communication link for transmitting the digital content from the computer, and a digital picture frame device. The digital picture frame devices includes a display screen, a frame surrounding a periphery of the display screen, wherein the frame provides a visual border around the periphery of the display screen, an input for receiving the digital content from the second communication link, decryption circuitry for decrypting the encrypted digital content, and control circuitry for controlling a display of the digital content on the display screen.

In yet one more aspect, a digital picture frame system includes a server for storing digital content, wherein at least some of the digital content is encrypted, a first communication link for transmitting the digital content from the server, and a digital picture frame device. The digital picture frame device includes a display screen, a frame surrounding a periphery of the display screen, wherein the frame provides a visual border around the periphery of the display screen, an input for receiving the digital content from the first communication link, decryption circuitry for decrypting the encrypted digital content, and control circuitry for controlling a display of the decrypted digital content on the display screen.

Other objects and features of the present invention will become apparent by a review of the specification, claims and appended figures.

### BRIEF DESCRIPTION OF THE DRAWINGS

FIG. 1 is a block diagram of the digital picture frame system which includes a digital picture frame device, a server, and a computer.

FIG. 2 is a front view of the digital picture frame device.

FIG. 3 is a schematic diagram of the digital picture frame device.

FIG. 4 is a block diagram of another alternative embodiment of the digital picture frame system comprising a digital picture frame device, and a server.

FIG. 5 is a block diagram of another embodiment of the digital picture frame system which includes a digital picture frame device, a server, a router and a computer.

FIG. 6 is a front view of the digital picture frame device showing both image and calendar content on the display.

FIG. 7 is a front view of the digital picture frame device showing a full-screen display of a calendar month.

FIG. 8 is a front view of the digital picture frame device showing a full-screen display of a calendar year.

FIG. 9 is a front view of the digital picture frame device showing user information coupled to the calendar day information.

### DETAILED DESCRIPTION OF THE PREFERRED EMBODIMENTS

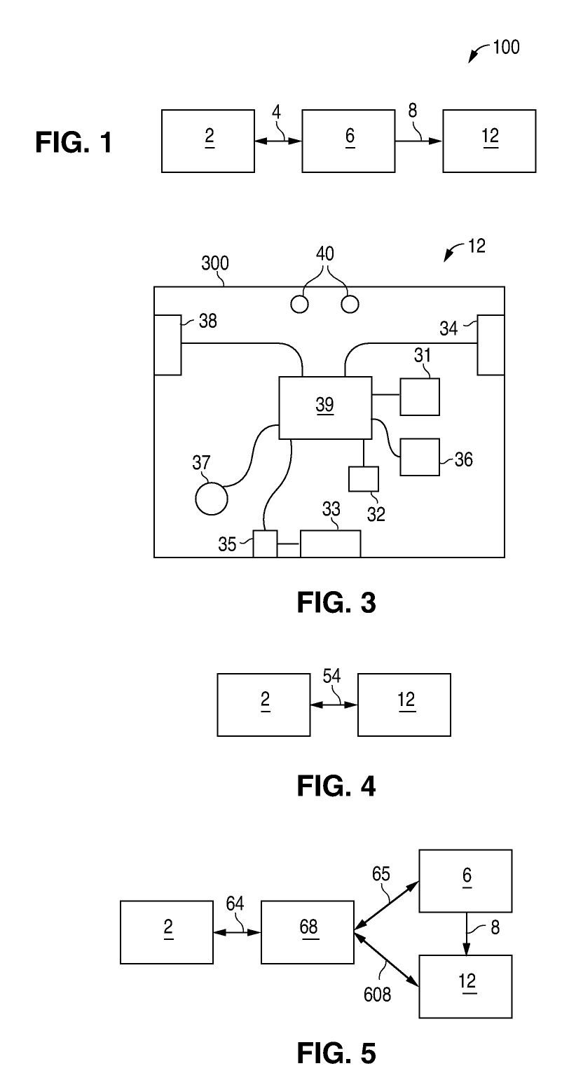

The present invention is a digital picture frame device and a system for supplying content to the device. The system 100 in FIG. 1 comprises a server 2, a computer 6, a digital picture frame device 12, a communication link 4 between the server 2 and the computer 6, and a communication link 8 between the computer 6 and the digital picture frame device 12.

In this configuration, the server 2 is a standard server hosting web based services. Users interact with the server 2 through a web page or any other appropriate communications protocol via communication link 4. The server 2 contains digital content that can be downloaded for free or only with payment of a fee (i.e. purchased or rented, such that the file or permission to read the file is permanently granted or expires after a period of time). While the digital content is shown as still images, digital content may be any format of information that can be displayed on the digital picture frame device 12, including but not limited to photographs, video, text, graphics and combinations of these forms of content.

In order to provide high-quality images, video and other digital content that has not originated with the user (third-party digital content) at a reasonably low cost to the user, it is desirable to limit the distribution of this content to the owners of the digital frame device 12. This limited distribution ensures a lower royalty or license fee from the copyright owners of the digital content, and thus a much lower cost to the user. In order to limit the distribution, the third-party digital content is resident in server 2 in an encrypted format that is then first decrypted for user review by a proprietary utility software program running on computer 6. The third-party digital content is also decrypted for display on the user's digital picture frame device 12 by electrical circuitry or by firmware resident in device 12. There are numerous well known encryption and decryption techniques that are suitable for downloading visual digital content, and are therefore not further discussed herein. Users request that the server 2 send content to the computer 6 via the communication link 4, which is preferably the Internet, but may be any communication network such as a dial up modem connection or a private wide area network capable of transferring digital content.

Computer 6 is a computing device (such as a personal computer with a hard drive, microprocessor, RAM, keyboard, pointer inputs, and display screen) running a utility software program. The utility software program is provided for download from server 2 to computer 6 to registered owners of digital picture frame device 12. When the computer 6 receives the content from the server 2, it stores that content in a library on some permanent form of memory. Additionally, the system 100 may include encoding software in the provided utility program on the computer 6. One aspect of the encoding software installed on the computer 6 is to accept user-provided digital content, such as pictures and videos, in a variety of formats and to encode them to match the specific digital picture frame device 12 selected by the user, as discussed in more detail below. This encoding ensures optimal display of the user-provided digital content on the digital picture frame device 12. The utility software installed on the computer 6 also includes the decryption capability to ensure the user is authorized to display any encrypted digital content that the user acquires from server 2 and to allow the user to preview the encrypted content on computer 6, also as discussed in more detail below. In this fashion, users have a library of both user-provided and acquired content tailored for their digital picture frame device 12. When users wish to display the content stored in the computer library on the digital picture frame device 12, they instruct the utility program to send the content over the communication link 8 to the digital picture frame device 12.

One application of the utility program is to modify user-provided digital content that is already resident in computer 6, for optimal display on the digital picture frame device 12. The user-provided content may be user-generated photos and video, or other digital content that the user has acquired from sources other than server 2. For example, the utility program can take user-generated images that are already resident on computer 6 in a variety of input formats, such as JPEG, BMP or TIFF formats and convert them all to JPEG format, and can take video input in MPEG1, MPEG2, MPEG4 and AVI format and convert them all to MPEG4 format. This allows the design of the digital picture frame device 12 to be simplified, in that it only has to be compatible with JPEG images and MPEG4 videos. The utility program also sizes and orients all user content so that the images will optimally fill the screen of the digital picture frame device 12. This will ensure optimal display of user-provided digital images and videos with minimal user effort.

In addition to reformatting, resizing and reorienting user-provided content, the utility program decrypts and displays encrypted content from server 2 that has been downloaded to computer 6. This decryption and display only allows the user to view the images in a preview format (i.e. the image is watermarked or small in size) so that if the user is interested in displaying the image with any enjoyable quality, the user would have to download the image to the picture frame device 12. The inability of users to view the images with full resolution on their computers would be a deterrent to unauthorized dissemination of third-party digital content. The utility program also provides the capability for the user to input user-specific date notations, such as birthdays, anniversaries, appointments, etc into calendar displays (as discussed below). Finally, the utility program can also provide the capability of arranging all content, both user-provided digital content and digital content downloaded from server 2, in user-designated playlists which can then be transferred to the digital picture frame device via communication link 8.

Communication link 8 is used for transmitting digital content from the computer 6 to the digital picture frame device 12. In one embodiment, communication link 8 is a USB memory device, such as a flash memory drive, or a removable hard drive, that can be physically transferred between a USB port on the computer 6 and a USB port on the digital picture frame device 12. In another embodiment, communication link 8 is a wireless connection between a transceiver contained in computer 6 and another transceiver contained in digital picture frame device 12. In another embodiment, communication link 8 may be a data transmission wire such as an Ethernet cable. Multiple sub-connections may also make up the connection, such as where the communication link 8 comprises a string of routers, as in the Internet or a local access network.

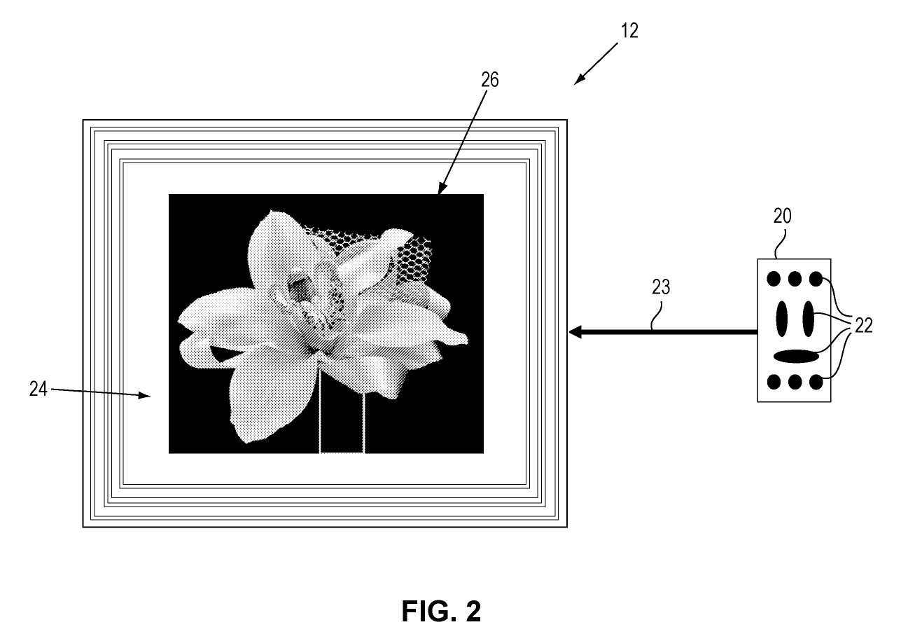

FIG. 2 illustrates a front view of digital picture frame device 12 in more detail. The digital picture frame device 12 includes a visual frame border 24 surrounding the perimeter of a display screen 26. The frame border 24 may be an elaborate border of virtually any material, or combination of materials (i.e. wood frame with matting), to enhance the aesthetic appearance of the device. Alternatively, it may be a simple wooden or plastic frame that provides a visual border to the display screen 26 and provides a mechanical support structure for the display screen 26. The display screen 26 is preferably thin, but may be any appropriate visual display screen such as an LCD, a plasma display, or a CRT. To ensure high-resolution display capability, the digital picture frame device preferably has a screen 26 with an area greater than 30 in² and a high pixel count preferably in excess of 6000 pixels/in². To ensure a high-quality display with good color and little distortion, the display screen 26 should be driven by a high-quality digital video driver.

Preferably, the digital picture frame device 12 includes a wireless remote control module 20 with control inputs 22 for sending commands to the digital picture frame device 12 via an infrared or RF communications link 23. Settings such as screen brightness, single photo or slide show settings, calendar input content, power saving options, and connections to the host computer may be set using control inputs 22. Alternatively, the control inputs 22 may be positioned on the digital picture frame device itself. In that case, the control inputs 22 may be any type of control such as buttons or knobs set in the frame border 24. Alternatively, the control inputs 22 may be placed in any physical position on the digital picture frame device 12. In one embodiment, the display screen 26 is a touch sensitive device where control inputs 22 for the digital picture frame device 12 or the system 100 constitute softkeys or menus on the touch screen display.

FIG. 3 illustrates a schematic of the digital picture frame device 12. The digital picture frame device 12 contains control circuitry 39 for controlling the various parts of the device. For embodiments that include the remote control 20, the control circuitry 39 controls the various parts of the device in response to or in conjunction with remote control 20. As such, control circuitry 39 is preferably electrically connected, by wire or infrared or RF signal, to all of the parts described below which require control. The device 12 also contains circuitry 36 for decrypting encrypted digital content received from the computer 6. Circuitry 36 may be electrical circuitry, firmware, or a combination of both. The decrypted content is then displayed on the display screen 26, preferably under the control of circuitry 36 and/or circuitry 39. The circuitry 36 may be incorporated as part of the control circuitry 39 instead of being completely separate as shown. The digital picture frame device 12 also includes memory 31 for storing any software drivers usable for displaying the content on display screen 26, and may also be used to store the digital content. A housing 300 is used for enclosing and protecting the internal parts of the frame device 12. The frame housing 300 may contain mounts 40 for hanging the device on a wall, or for attaching a stand for tabletop placement.

The digital picture frame device 12 contains an input 34 for receiving digital content. The input 34 may be a USB port, a wireless transceiver, a port for a removable cable, or any other input capable of receiving digital content. A power input 33 receives power via a cord from an electrical outlet. This presents an aesthetic issue for the wall-mounted device. To minimize the negative visual image of a power cord hanging down from the device, the power cord may be flat with an essentially transparent outer coating. In addition, this flat power cord may be attached to the wall with clear double-sided tape. Alternatively or additionally, the device 12 may contain one or more batteries 35 which can receive charging power from the power input 33. In this fashion, the digital picture frame device 12 may function as a wall- or desk-mounted display, and still serve to display its encrypted digital content when the power is interrupted.

The digital picture frame device 12 contains an internal clock 32 that keeps track of time and date. This clock 32 may be any suitable electronic device or may be an external clock signal incorporated into control circuitry 39. The clock 32 may be used to modify an active display of the frame device 12 such as slide show speed, to coordinate displayed images with calendar dates, and to synchronize various calendar functions as described in more detail below. Alternately or additionally, the clock 32 may be used to execute timed power on and power off commands.

The digital picture frame device 12 contains an optional sensing device 38 set to respond to certain events. In one embodiment, the sensing device 38 is a motion detector that causes the digital picture frame device 12 to display a repeating sequence of pictures whenever motion is detected. In another embodiment, sensing device 38 is a light detector set to lower the display intensity or turn the power off altogether whenever the level of ambient light in the room drops below a certain threshold. In another embodiment, sensing device 38 is a microphone which causes the digital picture frame device 12 to respond to sound-based commands. Sensing device 38 is optional, and may include any, none, or all of the above within the digital picture frame device 12. Output speaker 37 may also be included in the digital picture frame device 12 for purposes such as associating video or pictures with sound, or providing verbal information about settings.

In operation, the system 100 functions by starting with digital content, some of which may be encrypted, on the server 2. A new user interacts with the server 2 via web software, and registers their digital picture frame device 12 in a user account with the server 2. This permits the user to download the utility software program from server 2 over communication link 4 onto their computer 6. The user may then also purchase the right to display certain digital content, including the encrypted digital content, that is resident on the server 2, and download this content to their computer 6 over communication link 4. The computer 6 may already contain a library of content, the user-provided digital content, that has been previously obtained from user-generated files or from other sources. The utility software running on computer 6 encodes the user-provided digital content that has been selected by the user so as to provide optimal display on the user's digital picture frame device 12. The utility program also decrypts the encrypted digital content from server 2 to allow a user preview on computer 6. The computer 6 then transfers digital content, both user-provided and content from the server 2, to the frame device 12 via communication link 8. The frame device 12 receives the content at input 34. The digital content may reside in communication link 8 during operation of the picture frame device 12 if that link is a physical memory device such as a flash memory drive or a removable hard drive. Alternatively, the digital content may be transferred from input 34 to memory 31 where it is stored waiting to be displayed, which is done under the control of control circuitry 39. When communication link 8 has no inherent storage memory, as would be the case for a wireless link or a data transmission wire (e.g. Ethernet) link, then the digital content may be stored in memory 31. Control circuitry 39 responds to settings or inputs from control inputs 22, sensing device 38 or clock 32 to determine when, and in what sequence, to display the content stored in communication link 8 or memory 31. When control circuitry 39 determines that digital content should be displayed, it uses decrypting circuitry 36 to decrypt and display the encrypted content on the display screen 26. Additionally, control circuitry 39 may respond to sensing device 38 inputs to manipulate interactive content while it is being displayed. Control circuitry 39 may also respond to clock 32 to determine which content should be displayed and to automatically power the frame device 12 on and off. This describes one possible operation of the system. Many possible combinations of the parts of the system are possible.

FIG. 4 shows another alternative embodiment of the system which comprises a server 2, a digital picture frame device 12, and a communication link 54. This embodiment is different from the system of FIG. 1, in that the digital content, some of which may be encrypted, is transferred directly from the server 2 to the digital picture frame device 12 without passing through or being stored on a computer 6. In this embodiment, communication link 54 may be any network, but is preferably the Internet. Users use the picture frame device 12 to interface with the server 2, and give instructions to the server 2 on what content to send to the frame device 12. This content may be displayed or first stored in memory 31 for subsequent display. The encrypted digital content is decrypted by circuitry 36 in the digital picture frame device 12. Users may interface with the server 2 using controls 22. Alternatively, users may communicate with the server 2 using a separate computer to control the transfer of digital content to the frame device 12. Communication with the server 2 preferably occurs through a web page with an account login using server browser software running on the digital picture frame device 12.

FIG. 5 shows another alternative embodiment of the system which includes a server 2, a router 68, a communication link 64 between the server 2 and the router 68, computer 6, digital picture frame device 12, and communication links 65 and 608 between the router 68 and both the computer 6 and the frame device 12, respectively. This system configuration may essentially operate as a combination of the previously described embodiments.

Here, digital content, some of which may be encrypted, may be transferred from the server 2 to the computer 6 and stored in a library. Also, the content may simply be created or previously stored on the computer 6. In both of these cases, the content is transferred to the digital picture frame device 12 from the computer 6 either through router 68 and communication links 65 and 608 or through a direct link 8 between computer 6 and frame device 12. Alternately, the digital content may be sent directly to the digital picture frame device 12 from the server 2 over communication link 64, router 68 and communication link 608. The addition of router 68 adds versatility to the transfer and storage of the digital content.

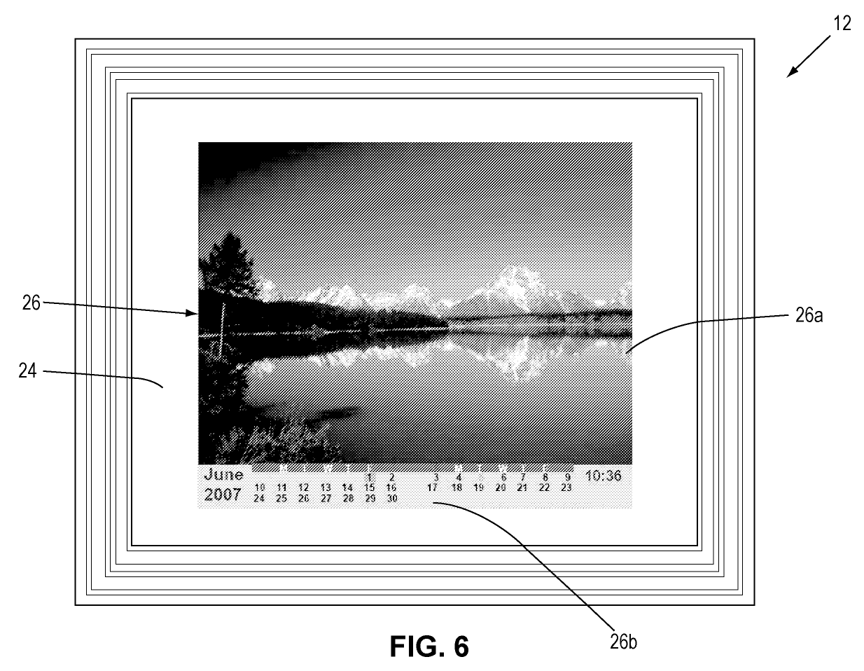

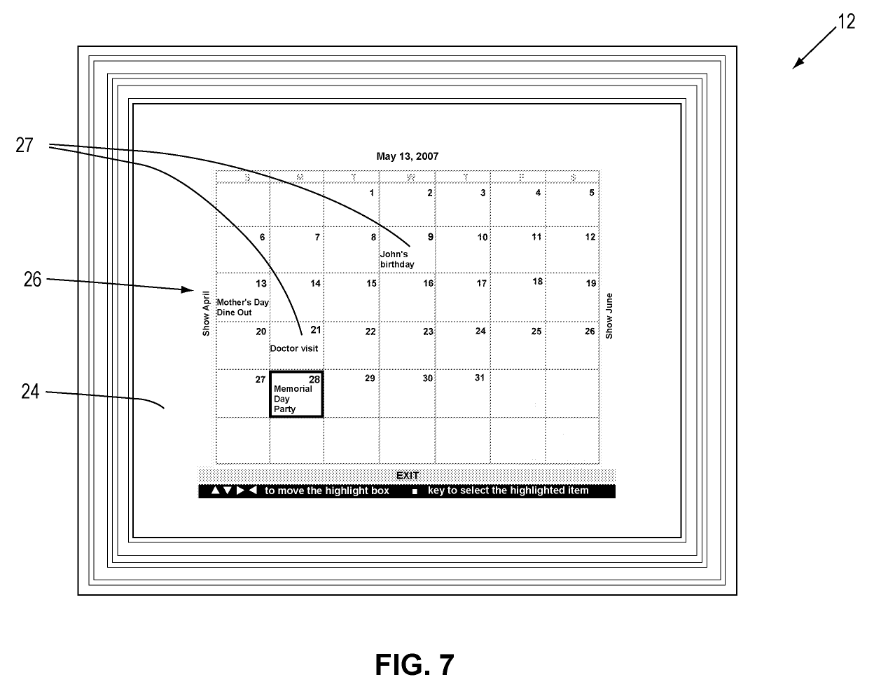

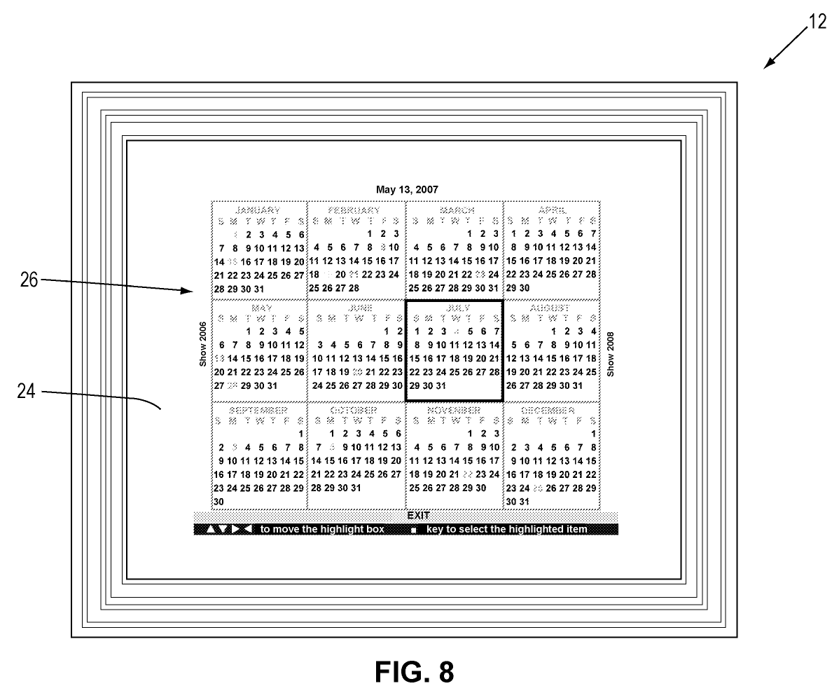

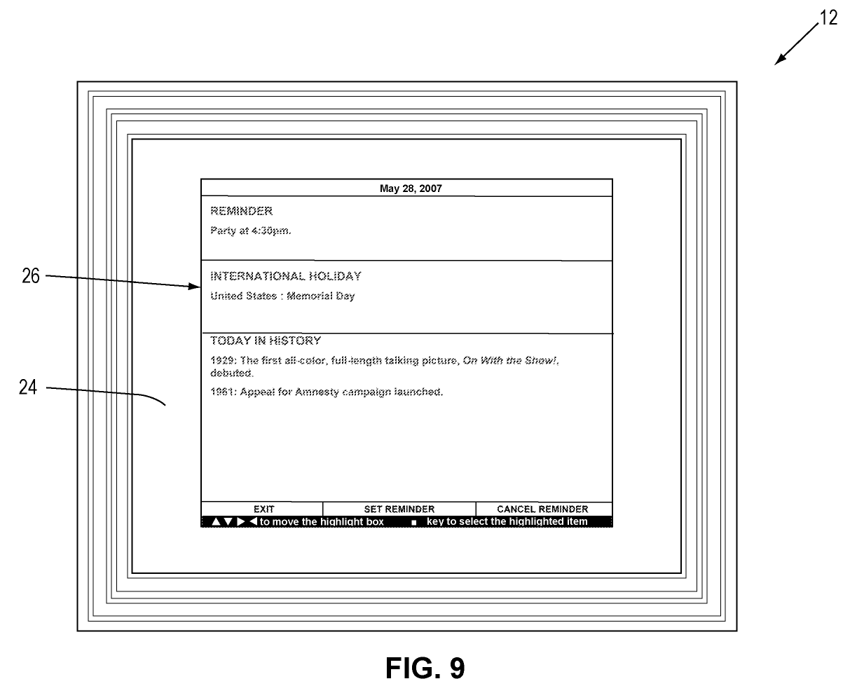

The digital picture frame system and device can also display calendar information. For example, as shown in FIG. 6, the display screen 26 of the digital picture frame device 12 can be composed of both an image section 26a (for displaying the digital content) and a calendar section 26b (for displaying a calendar, such as a current month calendar, along with a time of day clock indicator). Using controls 22, the user may alternately select to display a full-screen month calendar (as shown in FIG. 7), a full-screen display of two or three months, or even a full-screen calendar year (as shown in FIG. 8). Where appropriate, the calendar displays may include well known general calendar notations, such as holidays, lunar phases, etc. The user can also enter (using the control buttons 22 and/or the utility software program on computer 6) user-specific notations to the calendar displays such as birthdays, anniversaries, appointments, etc., 27, for display on screen 26 as shown in FIG. 7. Using controls 22, the user can select any date in the full-screen month display of FIG. 7 and then view all calendar and user-specific notations for the date selected as shown in FIG. 9. Various calendar templates can be available for download from server 2 or encoded in control circuitry 39 in device 12. The internal clock 32 is used to keep the various calendar displays current.

It is to be understood that the present invention is not limited to the embodiments described above and illustrated herein, but encompasses any and all variations falling within the scope of the appended claims. The displayed content may include information such as the time, a calendar, scheduling information, current news, stock quotes, traffic conditions, and/or text and images from a book. For example, depending on the sensing device(s) 38 contained in the digital picture frame device 12, or the user controls 22, the digital picture frame device 12 may be used to display digital content that tells an interactive children's story in response to inputs or that provides text and image reference material such as from a cookbook or a medical or technical reference book. Lastly, encryption/decryption at the server 2, computer 6 and/or picture frame device 12, and control circuitry at picture frame device 12, and remote control module 20, can be implemented by software, firmware, dedicated circuitry, or combination thereof. Therefore, for the purposes of this disclosure, circuitry for encrypting or decrypting digital content, and circuitry for controlling and displaying digital content, can include software and/or firmware running on a micro-controller, CPU or other circuit, and/or a preprogrammed or non-programmable electronic circuit.

1. A digital picture frame device for displaying digital content, comprising:
a display screen;
a frame surrounding a periphery of the display screen, wherein the frame provides a visual border around the periphery of the display screen;
an input for receiving digital content, wherein at least some of the digital content is encrypted;
decryption circuitry for decrypting the encrypted digital content; and
control circuitry for controlling a display of the decrypted digital content on the display screen.

2. The device of claim 1, further comprising an internal memory for storing the digital content received by the input.

3. The device of claim 1, wherein the input is a USB port.

4. The device of claim 3, further comprising:
a removable memory drive attachable to the USB port for storing the digital content.

5. The device of claim 1, wherein the input is a wireless transceiver.

6. The device of claim 1, wherein the input is an electrical connector for a data transmission wire.

7. The device of claim 1, further comprising:
a motion sensor, wherein the control circuitry causes the display of the digital content on the display screen in response to motion detected by the motion sensor.

8. The device of claim 1, further comprising:
a microphone, wherein the control circuitry causes the display of the digital content on the display screen in response to sound detected by the microphone.

9. The device of claim 1, further comprising:
a clock for keeping date and time, wherein the control circuitry modifies an active display of the digital content on the display screen in response to the clock.

10. The device of claim 9, wherein the control circuitry causes the display screen to display calendar information.

11. The device of claim 9, wherein the control circuitry causes the display screen to display user-specific calendar notations.

12. A digital picture frame system for displaying digital content, comprising:
a server for storing digital content, wherein at least some of the digital content is encrypted;
a first communication link for transmitting the digital content from the server;
a computer for receiving the digital content from the server, and for decrypting the encrypted digital content and displaying the digital content;
a second communication link for transmitting the digital content from the computer; and
a digital picture frame device that comprises:
a display screen,
a frame surrounding a periphery of the display screen, wherein the frame provides a visual border around the periphery of the display screen,
an input for receiving the digital content from the second communication link,
decryption circuitry for decrypting the encrypted digital content, and
control circuitry for controlling a display of the digital content on the display screen.

13. The device of claim 12, wherein the digital picture frame device further comprises:
an internal memory for storing the digital content received by the input.

14. The system of claim 12, wherein the first communication link is the Internet.

15. The system of claim 12, wherein the input is a USB port.

16. The system of claim 15, further comprising:
a removable memory drive attachable to the USB port for storing the digital content.

17. The system of claim 12, wherein the input is a wireless transceiver.

18. The system of claim 12, wherein the input is an electrical connector for a data transmission wire.

19. The system of claim 12, wherein the digital picture frame device further comprises:
a motion sensor, wherein the control circuitry causes the display of the digital content on the display screen in response to motion detected by the motion sensor.

20. The system of claim 12, wherein the digital picture frame device further comprises:
a microphone, wherein the control circuitry causes the display of the digital content on the display screen in response to sound detected by the microphone.

21. The system of claim 12, wherein the digital picture frame device further comprises:
a clock for keeping date and time, wherein the control circuitry modifies an active display of the digital content on the display screen in response to the clock.

22. The device of claim 21, wherein the control circuitry causes the display screen to display calendar information.

23. The device of claim 21, wherein the control circuitry causes the display screen to display user-specific calendar notations.

24. A digital picture frame system, comprising:
a server for storing digital content, wherein at least some of the digital content is encrypted;
a first communication link for transmitting the digital content from the server;
a digital picture frame device that comprises:
a display screen,
a frame surrounding a periphery of the display screen, wherein the frame provides a visual border around the periphery of the display screen,
an input for receiving the digital content from the first communication link,
decryption circuitry for decrypting the encrypted digital content, and
control circuitry for controlling a display of the decrypted digital content on the display screen.

25. The system of claim 24, wherein the first communications link comprises a router connected between the server and the digital picture frame device.

26. The system of claim 25, further comprising:
a computer connected to the router for receiving the digital content from the router, and for decrypting the encrypted digital content and displaying the decrypted digital content.

27. The system of claim 24, wherein the digital picture frame device further comprises an internal memory for storing the digital content received by the input.

28. The system of claim 24, wherein the first communication link is the Internet.

29. The system of claim 24, wherein the input is a USB port.

30. The system of claim 29, further comprising:
a removable memory drive attachable to the USB port for storing the digital content.

31. The system of claim 24, wherein the input is a wireless transceiver.

32. The system of claim 24, wherein the input is an electrical connector for a data transmission wire.

33. The system of claim 24, wherein the digital picture frame device further comprises:
a motion sensor, wherein the control circuitry causes the display of the digital content on the display screen in response to motion detected by the motion sensor.

34. The system of claim 24, wherein the digital picture frame device further comprises:
a microphone, wherein the control circuitry causes the display of the digital content on the display screen in response to sound detected by the microphone.

35. The system of claim 24, wherein the digital picture frame device further comprises:
a clock for keeping date and time, wherein the control circuitry modifies an active display of the digital content on the display screen in response to the clock.

36. The device of claim 35, wherein the control circuitry causes the display screen to display calendar information.

37. The device of claim 35, wherein the control circuitry causes the display screen to display user-specific calendar notations.
